(19) United States
(12) Patent Application Publication
(10) Pub. No.: US 2008/0283587 A1
(43) Pub. Date: Nov. 20, 2008

(54) Method and system for retrieval of consumer product information

(76) Inventors: Anita Joy Bateman, Austin, TX (US); Hung The Dinh, Austin, TX (US); David P. Lee, Round Rock, TX (US)

Correspondence Address: IBM CORPORATION;C/O DARCELL WALKER, ATTORNEY AT LAW, P. O. Box 25048, HOUSTON, TX, 77265, US

(21) Appl. No.: 12/154,214

(22) Filed: May 21, 2008

Related U.S. Application Data
(62) Division of application No. 11/348,972, filed on Feb. 7, 2006.

(51) Int. Cl. G06F 17/00

(52) U.S. Cl. 235/375

(57) ABSTRACT

A system comprising a product tag, a consumer receiver and software for the receiver enables a consumer to electronically retrieve information about commercial product. Each product would have a tag that could contain any amount of description information about the product. The tag has the capability of transmitting this information to a consumer. A customizable and programmable receiver can read the product tag and interpret the information according to the consumer's preferences programmed on the receiver. The software would allow the receiver to interpret the product tag information into an understandable format and present it to the consumer. This system enables a consumer to more efficiently and effectively obtain information about a commercial product.

### FIELD OF THE INVENTION

The present invention provides a method and system for a consumer to obtain information about a commercial product and more particularly it provides a method and system for obtaining information about a commercial product by using a portable electronic device to read information from a tag attached to the commercial product and then interpret and convey that information to the consumer in a format predefined by the consumer.

### BACKGROUND OF THE INVENTION

Commercial product packages contain information related to the content and use of the product. The information can be important to consumers considering the purchase of the product. However, many times this information is not easily accessible, readable or understandable for the consumer. Today this product information is normally provided in small text on the product, or is often provided in a separate location from the product. For example, clothing labels contain the material makeup, clothing size and care instructions, often on several labels attached to the clothing. Packaged food typically has nutrition information and cooking directions provided on the product, but suggested recipes provided elsewhere. Prescription medication typically has recommended dosage and basic information provided on the medication container, but side effects, drug interactions and further details are provided elsewhere.

The location and size of information many times creates a problem for consumers in using the information to understand a product and use it correctly. In addition, consumers with limited vision, color blindness, language difficulties (non-native English speakers, etc.) and other challenges have added difficulties when they cannot use the information provided about the product. Some known solutions to these problems are: 1) Using a magnifying glass to be able to read product labels with small print; 2) Providing product information on a separate internet website in multiple languages; and 3) Using another trusted person to help understand and use the product—specifically for color blind or non-native English speakers. All of these solutions are deficient because they do not allow the consumer to work with the product as-is, without either seeking additional information elsewhere or additional help from other persons. A consumer should be able to correctly use a product without having to expend additional effort to understand the product and its usage.

Many merchants use Radio Frequency Identification systems (RFID), particularly in inventory tracking of products. These RFID systems are used to identify retail items by reading electronic information stored within tags or labels on the items. These systems can be used to remotely identify physical objects by the response signal sent back by the tag. An RFID system typically employs at least two components, a “transponder” or “tag,” which is attached to the physical item to be identified, and a “reader,” which sends an electromagnetic signal the transponder and then detects a response. Typically, the reader emits a RF signal, which is received by the transponder, after the transponder comes within an appropriate range. In response to the signal from the reader, the transponder sends a modulated RF signal sent back to the reader. The reader detects this modulated signal, and can identify the transponder by decoding the modulated signal. After identifying the transponder, the reader can either store the decoded information or transmit the decoded signal to a computer.

The transponder used in an RFID system may be either “passive” or “active.” A passive transponder can be a simple resonant circuit, including an inductive coil and a capacitor. Passive transponders are generally powered by the carrier signal transmitted from the reader. Active transponders, on the other hand, generally include transistors or other active circuitry, and require their own battery source.

Bar code tags also contain information about products. These bar codes can contain information such as the identity of the product and the price of the product. Bar codes comprise a set of bars that correspond to a set of numbers. Each number or set of numbers represents certain information about the product. Each time a bar code scan occurs, the numbers are read and calculations performed to determine the information about the product. The benefit of the bar code system is that information about a product is quickly determined. In addition, the bar code system makes it easier to track the movement of products.

Bar code and RFID technologies are constantly being developed to better improve the ability to provide and track information about a product. For example, U.S. Pat. No. 6,415,978 describes a multiple technology data reader, for reading bar code labels and RFID tags. The multiple technology data reader includes a bar code reader and a radio frequency identification (RFID) reader, connected to a host computer via a computer bus, such as a universal serial bus (USB). The bar code reader and the RFID reader communicate with the host computer through logically independent data pipes and device drivers. Compound, composite, or complex interface implementations are possible. A single electronic interface may be configured to allow a single host computer to logically communicate with the bar code and RFID readers as either separate independent readers, or as a single cooperative multi-format label/tag data reader. Thus, the bar code and RFID readers may be operated independently, or powered and operated simultaneously.

U.S. Pat. No. 6,677,852 describes a system and method for automatically controlling or configuring, a device, such as an RFID Reader, reads a master control tag to upload sets of instructions from the tag to memory resident in the reader. Thereafter, the reader may read a control tag to select one or more sets of instructions stored in memory. The reader may thus be readily programmed without the need for physically connecting the reader to a computer, and without employing expensive keypads and display screens.

Even though bar code and RFID technologies exist, the ability of consumers to adequately obtain information about certain products is still a major challenge. There remains a need for a method and system that will enable various consumers to obtain information about a product that is important to that consumer. In addition, there remains a need for a method and system that will enable a consumer to determine the information that consumer wants to retrieve about a product and in some situations the manner in which they want to retrieve the information.

### SUMMARY OF THE INVENTION

It is an objective of the present invention to provide a method and system for the retrieval product information by a consumer.

It is a second objective of the present invention to provide a product identification system that provides product information to a consumer.

It is a third objective of the present invention to provide a product identification tag for attachment to a product that can transmit information about the product to a consumer.

It is a fourth objective of the present invention to provide a method in which a consumer can determine the information the consumer wants to retrieve about a product.

It is a fifth objective of the present invention to provide a method in which a consumer can determine the format in which the consumer wants to receive product information.

The system of the present invention comprises three components: a product tag, a consumer receiver and software for the receiver. Each product would have a tag that could contain any amount of description information about the product. This information may include basic features, usage, manufacture's information, etc, depending on nature of the product. The tag can have the capability of transmitting this information to a consumer. A customizable and programmable receiver can read the product tag and interpret the information according to the consumer's preferences programmed on the receiver. The software would allow the receiver to interpret the product tag information into an understandable format and present it to the consumer. Depending on the receiver capability, the software may allow the consumer to customize the output format, manipulate the product tag information locally and augment the data with user-specific information. The receiver can then display to the consumer the information about the product that the consumer wants to receive.

Product tags have been commonly used to improve manufacturing processes in the current marketplace. The use of product tags in the present invention is unique because of its design for the benefit of the consumer, rather than the well-known manufacturing application.

In the method of the present invention, a consumer would activate the receiver software contained in the receiver. Depending on the capabilities of the receiver software, the consumer could input (specify) the information about the product that the consumer wants to receive. Next the consumer scans the product tag with the receiver device. The receiver scans in the product information. The receiver software processes the received information and outputs to the consumer the requested product information in the format specified by the consumer.

The present invention provides advantages over prior product information systems. One advantage is an increased amount of needed product information (proper usage, etc.) would be readily available with the product. A second advantage is that the product information could be provided in multiple languages, addressing the language limitations of the consumer. A third advantage is that the receiver could output the information in multiple formats (languages, font sizes, colors, etc), thus accommodating consumers with various impairments (limited vision, color blindness, etc). Related product information for sales or marketing purposes could also be provided on the tags.

### DESCRIPTION OF THE DRAWINGS

FIG. 1 is an overview configuration of the system of the present invention.

FIG. 2a is an example of information contained in a format for the request of product information by a consumer for a clothing item.

FIG. 2b is an example of product information contained on a product tag contained on a clothing item.

FIG. 3a is an example of information contained in a format for the request of product information by a consumer for a food item.

FIG. 3b is an example of product information contained on a product tag contained on a food item.

FIG. 4a is an example of information contained in a format for the request of product information by a consumer for a medicine item.

FIG. 4b is an example of product information contained on a product tag contained on a medicine item.

FIG. 5a is an example of information contained in a format for the request of product information by a consumer for an appliance item.

FIG. 5b is an example of product information contained on a product tag contained on an appliance item.

FIG. 6 is an illustration of a flow diagram for implementation of the method of the present invention.

FIG. 7 is an illustration of a detailed flow diagram for implementation of the method of the present invention.

### DETAILED DESCRIPTION OF THE INVENTION

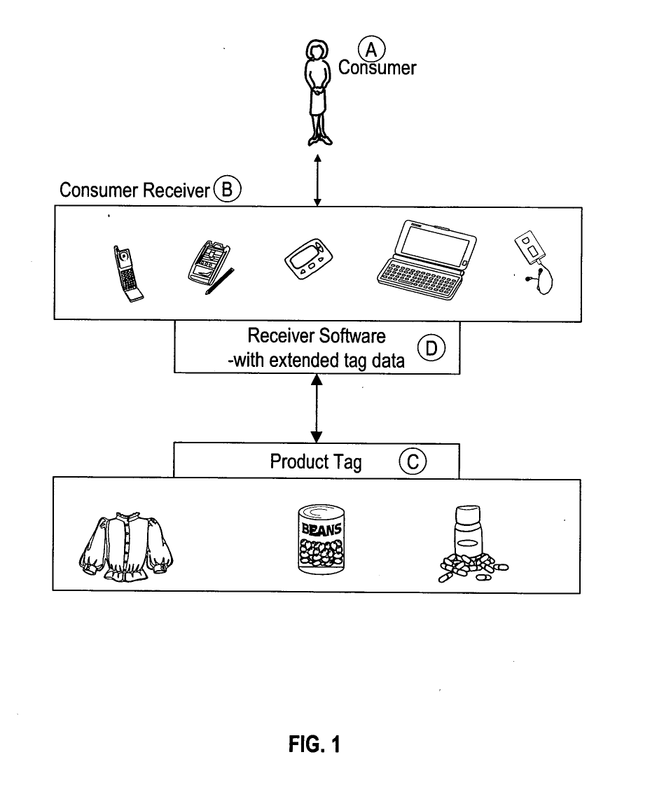

The present invention describes a method and system that enables a consumer to electronically receive information about a product that the consumer is considering for purchase. The system comprises a product tag attached to the commercial item, a receiver device controlled by the consumer and processing software in the receiver device to receive, process, interpret and output to the consumer the information about a particular product under consideration. FIG. 1 is an overview configuration of the system of the present invention. As shown, the consumer (A) uses the receiver (B) to receive information from the product tags (C) interpreted by receiver-specific software (D). The receiver (B) can be implemented using existing personal electronic/communication devices in the market, such as cellular telephones, PDA's. Preferably, the receiver can contain an RFID reader and be able to convey the RFID tag information in a format understandable to the user. The product tag (C) can also be implemented using an RFID tag. The tag could be applied and loaded with information by the manufacture or supplier of the product. As mentioned, RFID technology is widely available and relatively low cost to apply. Desirable benefits of using RFID technology in the consumer-oriented environment include: 1) Data extensibility compared with current static product labeling method; 2) No impact to tags from harsh environment (i.e. water, heat/cold, dirt); 3) Standard and customizable tags formats; and 4) Data can be both read and updated for reuse and consumer customization.

Specific software (D) may be installed in the receiver to allow the consumer to a desired output from the RFID reader. For example, the output could b voice, text display (various font, size color, language), printable media format (Braille, etc.) or any other format supportable by the software. The software may allow the consumer (A) to manipulate the product information locally or augment the RFID tag information with consumer-specific data, stored with the system.

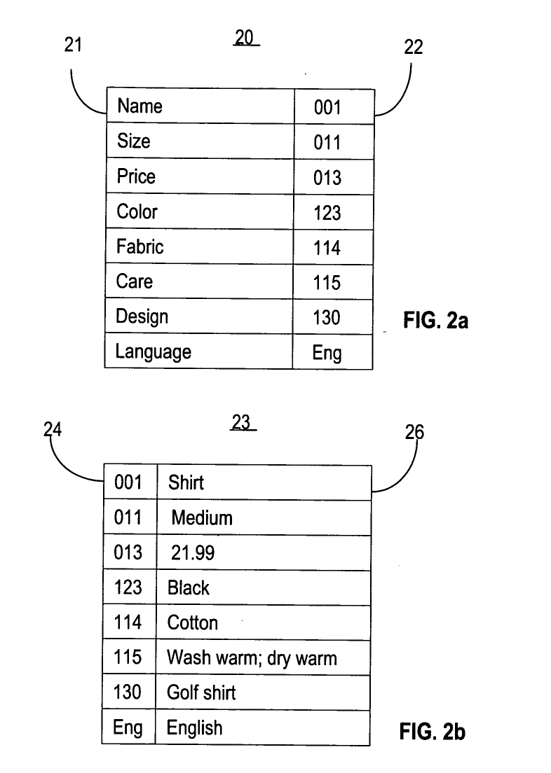

FIGS. 2 through 5 give illustrations of configurations for data stored on a product tag and data desired by a consumer that is used to manipulate and process the data retrieved from the product tag. FIG. 2a illustrates a format that can be used by the consumer to identify product criteria and information that the consumer wants to retrieve about the product from the product tag. This particular format is for a clothing item product in the consumer apparel industry. As shown, the consumer can submit a query seeking product information based on selected items that are related to features of the product. In the criteria identification process, there can be a record having multiple fields that correspond to different product information. In this format there are eight (8) criteria. The record 20 in FIG. 2a illustrates a criteria field 21 and a code field 22. The criteria field displays to particular type of information the consumer seeks. In addition to the information listed in FIG. 2a, other product can also be listed. This information can include things such as the identity of the product manufacturer, identity of the product distributor and product warranty information. The code field contains a number that corresponds to that particular piece of information contained on the product tag. FIG. 2b shows the product information contained in a record 23 on the product tag. This format also has two fields 24 and 26 per criteria item. The key is that both 2a and 2b have the same code field 21 and 24 respectively. Therefore, it is easy to match up the desired criteria identified by the consumer with the product information that corresponds to that product. In this example, a scan of the product would enable the consumer to retrieve all of the codes for the various pieces of information contained on the product tag. The reader software would retrieve the different codes and then select information for the consumer that corresponds to the codes identified by the consumer. The product tag could contain more product information than shown in FIG. 2b. In that event, there would be additional code fields and product description information. If the consumer only desired the product name, size, price color and fabric, the reader software would retrieve only that information from the product tag. The software would search for codes that correspond to that information and retrieve that information for conveyance to the consumer.

Initially, the consumer could input (punch in) the codes of the desired criteria. In another embodiment, there can be a set of default criteria (product name, size, color, price and fabric). With this default criteria approach, the user would not need to input specific consumer criteria. A scan would cause the software to only look for the information that corresponds to the default criteria codes.

In a particular scenario for a clothing item, a color blind or visually impaired consumer is shopping for clothing. The consumer could enter the codes for the specific product information that the consumer desires. There are various approaches for enter the information. One approach is for the consumer to enter individual codes for the desired information. In order to get the information for a product, the consumer could take their receiver and scan the tag on the clothing item. The scanning process would cause the receiver to retrieve the product information stored on the product tag. In addition to the basic or default clothing information (size, price, color, fabric), the product tag could contain the care instructions and suggested related clothing purchases. As mentioned, the receiver software could match codes for requested data with corresponding product codes that contain that information. By having this information readily available in a usable format (visual or audio), this enables the consumer to understand the product, purchase it and use it correctly.

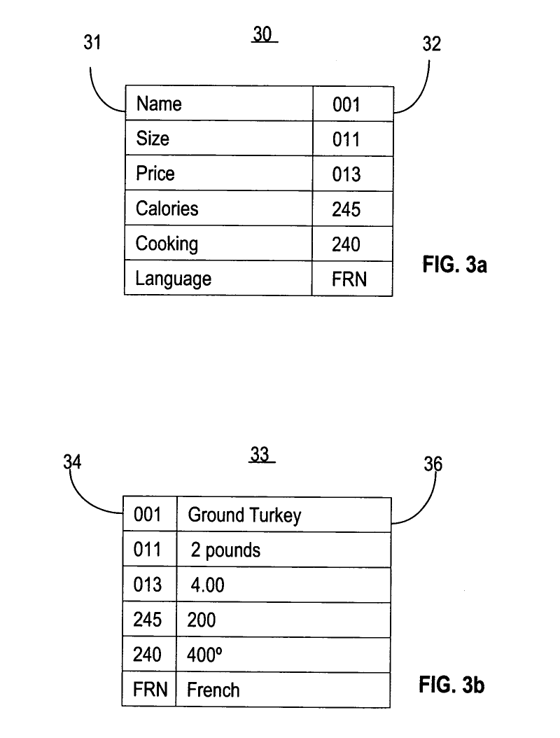

FIGS. 3a and 3b illustrate a similar format for a product item from the food or beverage industry. The listed criteria are only to illustrate the approach to retrieving product information. In an example of a food product item, a typical consumer is shopping for groceries. The consumer could take their receiver, scan the tag on the packaged food item and read out the product information. The product information could contain nutritional information, cooking instructions, suggested recipes, and other related information. If the consumer was visually impaired or non-native English speaker, the product information could be output in a readable and understandable format (either visual or audio) that is customized for the consumer.

In the present example, the FIG. 3a lists consumer product information criteria record 30 for a food item. This information shown in column 31 includes the product name, size, price, the number of calories, cooking instructions and the language in which the information is to be conveyed to the consumer. Each criterion has a specific code associated with it shown in column 32. As shown, the information in a product record 33 displays corresponds to each code 34 is shown in FIG. 3b in column 36.

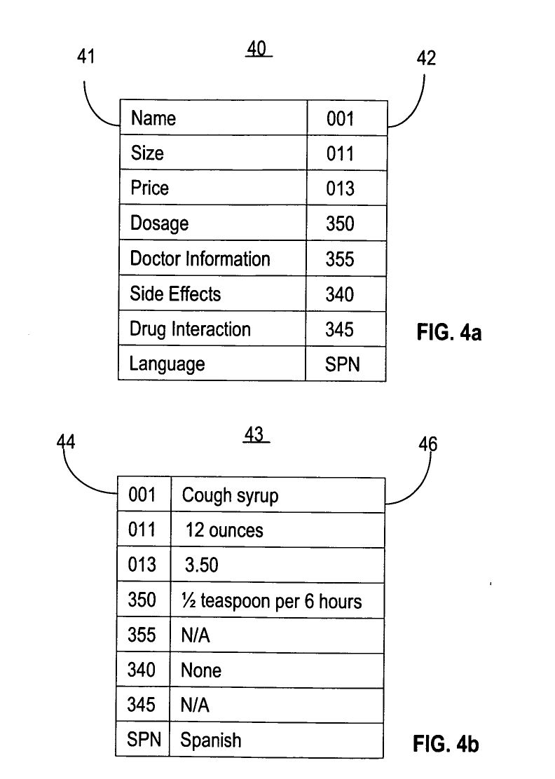

FIGS. 4a and 4b illustrate an application of the present invention in the healthcare or pharmaceutical industries. In this application, a consumer is purchasing over-the-counter medication. The consumer uses their receiver to scan the product tag of medication and receive a processed output the medication's information. Again, the product information criteria are listed in FIG. 4a. The product criterion is shown in record 40 in which product criteria identifications in column 41 and the corresponding code is shown in column 42. Although not shown in this particular FIG. 4a, the product criteria could include basic information, dosage, prescribing doctor's information, side effects and drug interaction details. FIG. 4a is an example of the consumer requesting less information than is available about the product. This information shown in FIG. 4a could be an example of default criteria for a consumer. FIG. 4b contains the codes in column 44 and product description information in column 46.

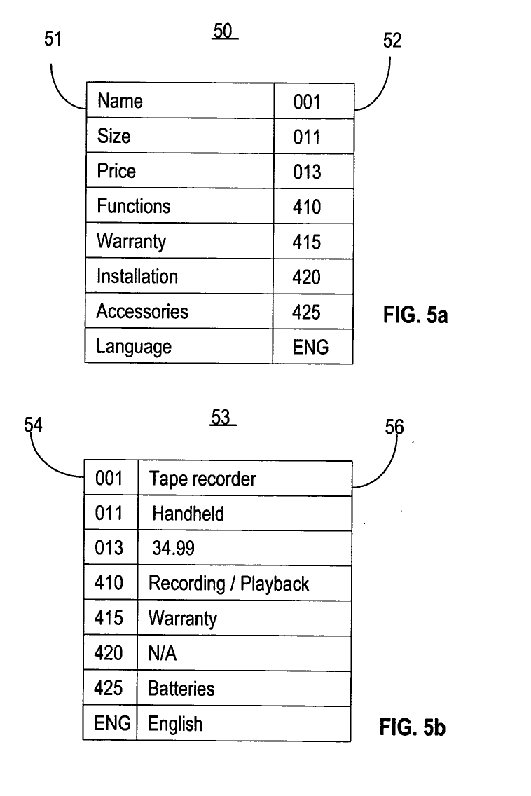

FIGS. 5a and 5b show the product criteria and product tag information for an electronic appliance. In the product query 50 in FIG. 5a, column 51 identifies the particular product information the consumer seeks. Column 52 shows the code that corresponds to a particular piece of product information. FIG. 5b shows a record 53 of the product information which contain the criterion codes in column 54 and the product information in column 56.

Again, referring to a consumer receiver device B, this device should have the capability to scan product tags, in particular the RFID tags, and retrieve product information contained on the tag. In addition, the receiver device may also have immediate or long-term storage capabilities that will enable a consumer to retrieve information from past product scans.

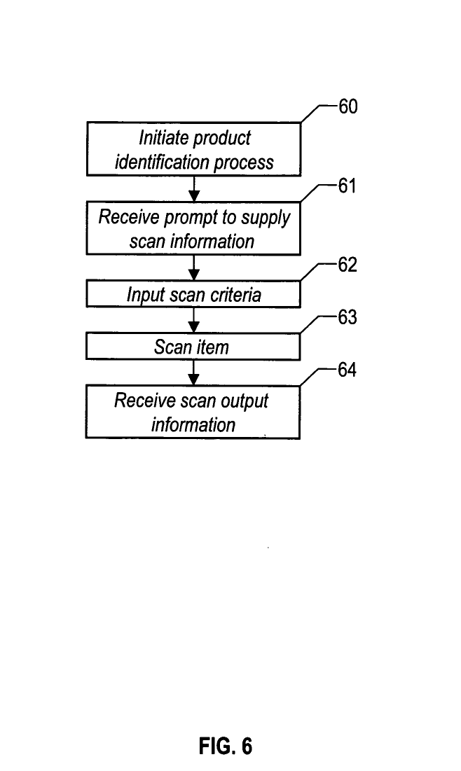

FIG. 6 illustrates the basic steps in the implementation of the method of the present invention. The first step 60 is to initialize or activate the software program in the receiver that will process and output the product information desired by the consumer. Once the program is activated, in step 61, the program will send a prompt to the consumer to supply the desired product criteria. In step 62, the consumer responds to the prompt by supplying product criteria. As mentioned, a primary way to respond to the prompt is to physically enter the codes for the desired pieces of product information. A second approach is to have the mentioned set of default criteria. A third approach is to respond to a series of audio or visual prompts by the receiver device. The receiver device could list various criteria and the consumer could have the option of selecting criteria from the list. With an audio approach, the consumer could respond to an audio prompt for each criterion. This process would be similar to the audio response process in other telephone type systems. When the consumer heard a criterion that the consumer desired, the consumer would respond audibly by saying ‘YES’. If the consumer did not want that criterion, the consumer would respond by saying ‘NO’.

Step 63 performs the scan of the product tag of the product for which the consumer has interest. This scan would retrieve the information contained on the product tag. After receipt of the scanned information, the software program processes the information and presents it to the consumer in step 64. Processing could involve selecting from the received information, the particular information desired by the consumer. As mentioned, the product tag may contain more information about the product than the consumer desires.

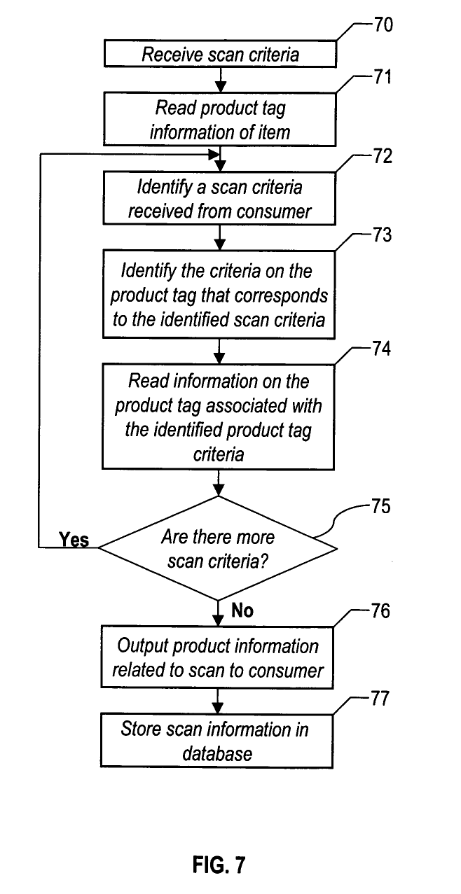

FIG. 7 illustrates a flow diagram of the processing steps performed in the software program when the consumer scans a product tag. In step 70, the product information received during the scan of the product tag is received at the consumer receiver B. Step 71 reads and processes the scanned information. In the clothing item example, all of the information codes are extracted from the received data by the software program. As part of this step, there is a determination of the number of criteria for which the consumer desires product information. This function could be accomplished by having a count of the number of codes that are read by the receiver. For example, in FIG. 2a, there are seven (7) codes that represent seven (7) pieces of information desired by the consumer. As a standard all codes in the system would have the same length or number of digits. Another requirement could be that all codes would be numeric. In the present example, the language would not be considered to be a search criterion and would not be considered as a piece of information to be searched. At this point, the retrieved product information and codes could be stored in a temporary memory location in the consumer receiver device.

Steps 72, 73 and 74 comprise the process of retrieving the product information desired by the consumer. In step 72, the software program identifies a consumer criterion. In this identification process, the software searches the column 22 of the search criteria record. The software identifies a criterion ‘001’. At this point, step 73 searches the product tag data retrieved during the scan. This search will be of column 24. This search in step 73 attempts to match a product tag entry with a search criterion from the consumer criteria record in FIG. 2a. In this example, there will be a match of ‘001’ codes for the both the scan criterion and the product tag information. At this point, step 74 reads and stores the product tag information for that code. In this example, the code ‘001’ is the product, which is a ‘shirt’. At point, step 75 determines if there are additional scan criteria. This determination could be the result of basic decrement of the number of scan criteria counted in step 71. Each time a criteria is matched and stored, the count would be reduced by one (1) until the count reached zero. If there are additional criteria, the process returns to step 72 and repeats steps 72, 73 and 74 for the next criteria. When the count of step 75 reaches zero, the method moves to step 76. During the count of step 71, the language field could be processed to indicate that this field is an output field and therefore would not show up as a criteria field or be included in the count. In this step, the stored information for the step 74 is output to the consumer as defined by the consumer. Step 78 is an optional step that enables the consumer to save a product search for use at another time, possibly to compare product information with similar products.

In this process, the retrieval information from the product tag and the processing of that information can be done one criteria at a time or by gathering all of the product information. This process involves steps 71 through 75. When done one criteria at a time, the scanner would read a consumer criteria and find the corresponding information on the product tag, then retrieve and store that information on the consumer receiver device. This process would repeat for each criteria identified by the consumer. In other approach, all of the product tag information would be read or downloaded into the consumer device at one time. The software program would then select the information that corresponds to the criteria defined by the consumer. The other product information would be not be stored on the consumer receiver device. The distinction between the two methods is that in the latter method all of the processing occurs in the consumer receiver. In the former method, the software program makes final information determinations prior to retrieving or downloading information from the product tag.

The present invention provides an alternative approach to the retrieval of commercial product information by a consumer. It is important to note that while the present invention has been described in the context of a fully functioning data processing system, those skilled in the art will appreciate that the processes of the present invention are capable of being distributed in the form of instructions in a computer readable medium and a variety of other forms, regardless of the particular type of medium used to carry out the distribution. Examples of computer readable media include media such as EPROM, ROM, tape, paper, floppy disc, hard disk drive, RAM, and CD-ROMs and transmission-type of media, such as digital and analog communications links.

Having thus described the invention, what we claim as new and desire to secure by Letters Patent is set forth in the following claims.

I claim:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. A system for electronic retrieval of consumer product information comprising: a product tag attached to a commercial product, said tag containing information about the commercial product and said tag capable of transmitting information contained on the product tag:
a portable receiver device capable of receiving formation transmitted from said product tag;
a software program contained in said portable receiver device for displaying information retrieved from said product tag according to the desires of a consumer; and
a memory module contained in said portable receiver for storing information retrieved from said product tag.

21. The system as described in claim 20 wherein said portable receiver device further comprises a scanner function to retrieve information from said product tag.

22. The system as described in claim 20 wherein said memory module temporarily stores product tag information.

23. The system as described in claim 22 further comprising a product information database storage location to store information about various products on a long-term basis.

24. The system as described in claim 20 wherein said software program further comprises a product information criteria format for identifying product information a consumer desires about a product, the information criteria format comprising a plurality of records with each record having a product criteria field and a product criteria code.

25. The system as described in claim 24 wherein said product tag has information stored on said product tag in a product information format for identifying information about a product, the product information criteria format comprising a plurality of records with each record having a product criteria code and a field having product information.

26. The system as described in claim 20 wherein said product tag is a radio frequency identification (RFID) tag and the portable receiver device is a radio frequency identification (RFID) receiver.

27. The system as described in claim 20 wherein said portable receiver device has audio and visual output capabilities.

28. A method for electronic retrieval of consumer product information comprising the steps of:
retrieving product description criteria from a consumer interested in information about a commercial product;
retrieving information about a product contained on a product tag attached to the commercial product;
processing the retrieved product information based on the retrieved product description criteria; and
outputting to the consumer, customized information about the commercial product in accordance with the retrieved product description criteria.

29. The method as described in claim 28 wherein in said product description criteria retrieval step, product description criteria is retrieved by prompting a consumer to submit product description criteria through a portable r receiver device.

30. The method as described in claim 28 wherein in said product description criteria retrieval step, product description criteria is retrieved from a set of default product description criteria.

31. The method as described in claim 28 wherein said step of retrieving information contained on product tag is performing by scanning the information from the product tag and into a portable receiver device.

32. The method as described in claim 28 wherein said step of retrieving information contained on product tag is performing by transmitting product information from the product tag and receiving the transmitted product information at the portable receiver device.

33. The method as described in claim 28 wherein in said step of retrieving information contained on a product tag, information is retrieved by a portable receiver device one criterion at a time.

34. The method as described in claim 33 wherein said processing step information from a product tag is processed one criterion at a time.

35. The method as described in claim 28 wherein in said step of retrieving information contained on a product tag, all product tag information is retrieved by a portable receiver device one at a time.

36. The method as described in claim 28 wherein in said step of retrieving information contained on a product tag, all product tag information is processed by software in a portable receiver device one at a time.

37. The method as described in claim 28 further comprising after said outputting step, the step of storing retrieved and processed information about a product in a product description database.

38. A computer program product in a computer readable storage medium for electronic retrieval of consumer product information comprising:
instructions for retrieving product description criteria from a consumer interested in information about a commercial product;
instructions for retrieving information about a product contained on a product tag attached to the commercial product;
instructions for processing the retrieved product information based on the retrieved product description criteria; and
instructions for outputting to the consumer, customized information about the commercial product in accordance with the retrieved product description criteria.
